(19) United States
(12) Patent Application Publication
(10) Pub. No.: US 2003/0126051 A1
(43) Pub. Date: Jul. 3, 2003

(54) Method and system of providing access to public financing markets to companies with limited or negative net worth

(76) Inventor: Mohammad Salim, Edgewater, NJ (US)

Correspondence Address: FOLEY AND LARDNER, SUITE 500, 3000 K STREET NW, WASHINGTON, DC, 20007, US

(21) Appl. No.: 10/268,093

(22) Filed: Oct. 10, 2002

Related U.S. Application Data
(60) Provisional application No. 60/327,773, filed on Oct. 10, 2001.

(51) Int. Cl. G06F 17/60

(52) U.S. Cl. 705/35

(57) ABSTRACT

A method, system, and software for enhancing valuations of companies having limited or negative worth using a reverse merger, by identifying a suitable company based on financial and operational data of companies. Comparable listed companies on a target market or exchange are found to identify a target merger partner from the comparable listed companies based on a selection criteria. The suitable company and the target merger company are merged to form a new public entity that is listed in the target market or exchange; and at least some of the debt or liabilities in the suitable company is exchanged with equity in the new public entity.

### CROSS-REFERENCE TO RELATED APPLICATIONS

This application claims the benefit of priority under 35 U.S.C. §119(e) of provisional application serial No. 60/327,773, entitled “Method and System For Providing Access to Public Financing Markets to Companies with Limited or Negative Net Worth” filed on Oct. 10, 2001, the disclosure which is incorporated herein in its entirety

### FIELD OF THE INVENTION

The present invention provides a computer implemented method and system for identifying suitable companies that can be financed in certain capital markets, such as the US capital markets. Furthermore, the present invention provides a method of obtaining such financing whereby a sponsor shepherds suitable companies through the process of obtaining such financing by applying the method of the present invention

### BACKGROUND OF THE INVENTION

In many parts of the world today, such as in Japan, privately-held companies of significant size are illiquid and are unable to obtain access to capital needed for financing of growth. The US capital markets have been traditionally closed to all but the largest of such companies. Many such companies are further hampered by negative net worth resulting from loans (often real estate loans) taken out years ago when property values were far higher. Similarly, some companies have investments that have declined in value because of a decline in the markets equity or other similar financial instruments. Such companies are today effectively unfinanceable, even when they have substantial sales and operating profitably, and cannot be sold for anywhere near their true value.

### SUMMARY OF THE INVENTION

The present invention provides a method for identifying suitable companies that can be financed in the US capital markets. Furthermore, the present invention provides a method of obtaining such financing whereby a “Sponsor” shepherds suitable companies through the process of obtaining such financing by applying the methods of the present invention. A Sponsor is a third party familiar with accessing US capital markets and knowledgeable about aspects of obtaining financing in capital markets, such as having expertise in securities regulations. It should be understood that a Sponsor is a logically a third party—although one skilled in the art would understand that the Sponsor could also have an affiliation or relationship with a company that is seeking financing using the methods of the present invention.

In one aspect, the present invention provides a computer implemented method of enhancing valuations of companies having limited or negative worth using a reverse merger, including the steps of: identifying a suitable company based on financial and operational data of companies; finding comparable listed companies on a target market or exchange; identifying a target merger partner from the comparable listed companies based on a selection criteria; merging the suitable company and the target merger company to form a new public entity that is listed in the target market or exchange; and exchanging at least some of the debt or liabilities in the suitable company with equity in the new public entity.

In another aspect of the present invention, the step of identifying a suitable company comprises evaluating financial data of the companies.

In one aspect, the present invention provides that the the financial data includes one or more of sales history, cost of goods sold, assets, liabilities, or financial ratios.

In one aspect, the present invention provides that the the step of identifying a suitable company includes evaluating the financial data of a company against average or other aggregate values of other companies in a similar industry.

In another aspect of the present invention, the step of evaluating a suitable company includes evaluating operational data of companies including one or more of access or contracts to valuable resources, government contracts, geographical location, or intellectual property.

In one aspect of the present invention, the step of evaluating a suitable company includes evaluating both financial and operational data and deriving a ranking based on a composite value derived from both financial and operational data.

In one aspect, the present invention provides that the step of identifying suitable companies includes identifying companies with higher operating margins relative to their net worth.

In one aspect, the present invention provides that the step of finding a target merger partner includes selecting a company from the comparable listed companies using a selection criteria, wherein the selection criteria includes evaluating one or more of factors related to the companies including industry, company size, company sales, price/earnings ratio, price/sales ratio, type of product or service offered, amount and type of debt, geographical location, types and number of shareholders, and authorized versus issued shares.

In another aspect of the present invention, the selection criteria includes using a composite value developed from one or more of the factors.

In one aspect, the present invention provides that the step of exchanging at least some of the debt or liabilities comprises determining a target market capitalization, wherein the target market capitalization is determined based on the operational earnings of the suitable company or the new public entity, and financial ratios of comparable companies in the target market or exchange.

In one aspect of the present invention, the step of exchanging at least some of the debt or liabilities comprises determining an amount of the debt or liabilities to be exchanged based on the determination of the target market capitalization value.

In another aspect, the present invention provides a computer readable data medium having program code stored thereon for enhancing valuations of companies having a limited or negative net worth by causing a computing system to perform the steps including: identifying a suitable company based on financial and operational data of companies; finding comparable listed companies on a target market or exchange; identifying a target merger partner from the comparable listed companies based on a selection criteria; merging the suitable company and the target merger company to form a new public entity that is listed in the target market or exchange; and exchanging at least some of the debt or liabilities in the suitable company with equity in the new public entity.

In another aspect, the present invention provides a computing system for enhancing valuations of companies having limited or negative net worth using a reverse merger, including: means for finding comparable listed companies on a target market or exchange; means for identifying a target merger partner from the comparable listed companies based on a selection criteria; means for merging the suitable company and the target merger company to form a new public entity that is listed in the target market or exchange; and means for exchanging at least some of the debt or liabilities in the suitable company with equity in the new public entity.

### BRIEF DESCRIPTION OF THE DRAWINGS

FIG. 1 is a block diagram showing the components of a general purpose computer system connected to an electronic network.

FIG. 2 is a flow chart illustrating the high level steps of one embodiment of the present invention.

FIG. 3 shows a web page interface to an exemplary stock screener application.

FIG. 4 shows a table listing financial data for a suitable company.

FIG. 5 shows a table listing the share ownership in a new public entity.

FIG. 6 shows a table listing market valuation of shares owned by the original shareholders in the new public entity.

### DETAILED DESCRIPTION OF THE INVENTION

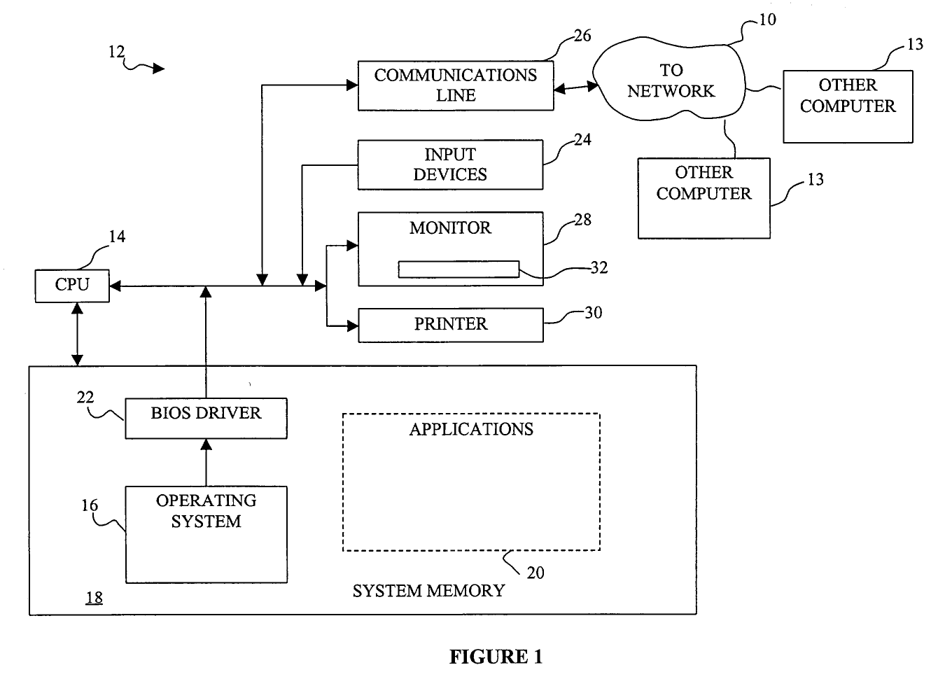

With reference to the figures, FIG. 1 is a block diagram showing the components of a general purpose computer system 12 connected to an electronic network 10, such as a computer network. The computer network 10 can also be a public network, such as the Internet or Metropolitan Area Network (MAN), or other private network, such as a corporate Local Area Network (LAN) or Wide Area Network (WAN), or a virtual private network. As shown in the FIG. 1, the computer system 12 includes a central processing unit (CPU) 14 connected to a system memory 18. The system memory 18 typically contains an operating system 16, a BIOS driver 22, and application programs 20. In addition, the computer system 12 contains input devices 24 such as a mouse and a keyboard 32, and output devices such as a printer 30 and a display monitor 28.

The computer system generally includes a communications interface 26, such as an ethernet card, to communicate to the electronic network 10. Other computer systems 13 and 13A may also be connected to the electronic network 10. One skilled in the art would recognize that the above system describes the typical components of a computer system connected to an electronic network. It should be appreciated that many other similar configurations are within the abilities of one skilled in the art and all of these configurations could be used with the methods of the present invention. Furthermore, it should be recognized that the computer system and network disclosed herein can be programmed and configured (if necessary into appropriate computing and/or communication units), by one skilled in the art, to implement the methods, system, and software discussed further herein as well as provide requisite computer data and electronic signals to implement the present invention.

In addition, one skilled in the art would recognize that the “computer” implemented invention described further herein may include components that are not computers per se but include devices such as Internet appliances and Programmable Logic Controllers (PLCs) that may be used to provide one or more of the functionalities discussed herein. Furthermore, while “electronic” networks are generically used to refer to the communications network connecting the processing sites of the present invention, one skilled in the art would recognize that such networks could be implemented using optical or other equivalent technologies.

One skilled in the art would recognize that other system configurations and data structures could be provided to implement the functionality of the present invention. All such configurations and data structures are considered to be within the scope of the present invention.

In this context, it is also to be understood that the present invention may utilize known security measures for transmission of electronic data across networks. Therefore, encryption, authentication, verification, and other security measures for transmission of electronic data across both public and private networks are provided, where necessary, using techniques that are well known to those skilled in the art.

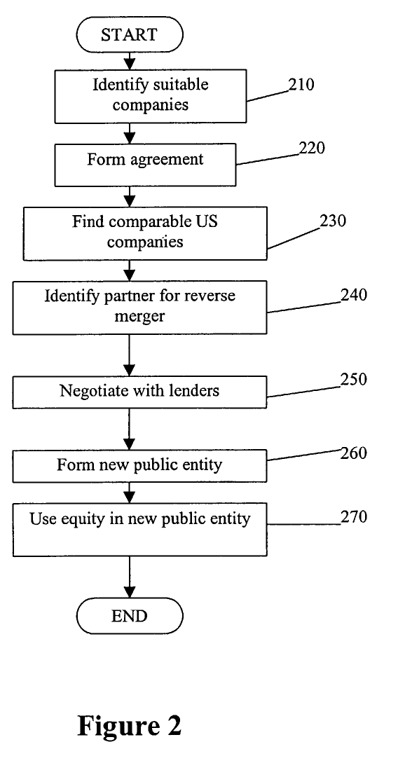

In one embodiment, as shown in FIG. 2, the present invention includes at least the following steps: (1) identifying suitable companies (step 210); (2) forming an agreement with the suitable companies (step 220); (3) finding comparable US listed companies (step 230); (4) identifying and valuing a partner for a reverse merger (step 240); (5) negotiation with lenders (step 250); (6) formation of new public entity (step 260); and (7) Using the equity in the new public entity (step 270). Each of these steps is discussed in greater detail further herein. FIG. 2 is merely an illustration and should not limit the present invention. One of ordinary skill in the art would recognize other variations, modifications, and alternatives all of which are within the scope of the present invention. One or more of these steps (or parts thereof) are implemented using a networked computer system such as that described earlier herein with respect to FIG. 1. Programming and configuring a computer system using commercially available and custom developed software, hardware, and networking components to implement these steps is within the abilities of one skilled in the art in view of the disclosure herein.

Identifying Suitable Companies (Step 210)

In the first phase, the Sponsor uses computer analysis to determine which companies may be suitable for application of this method. Financial data is collected or received about the candidate company, including for example (a) sales history, (b) cost of goods sold, (c) assets, and (d) liabilities. From this data, a computer implemented procedure is used to calculate common ratios or other indicia of (a) operating margins, (b) debt to equity ratios, (c) liquidity indices, and the like. One skilled in art would recognize that the financial data and financial ratios indicated above are representative only. Additional financial data and/or financial ratios may be input and calculated using a computer system to facilitate the identification of a suitable company for financing in accordance with the present invention.

Furthermore, in alternate embodiment, it is also possible that target companies may be identified based on operational data rather than simply financial data. For example, a company that has access to valuable resources such as access to natural resources, government contracts, geographical factors (location of facilities or markets), or intellectual property may also be a candidate for being identified as a target company even though their financial data and/or financial ratios may be inferior to others.

In one embodiment, candidate companies with favorable operating margins are identified as target companies. Companies with favorable operating margins are those companies with operating characteristics attractive to investors in comparison with similar characteristics for comparable publicly-traded companies. For example, a company with a profit margin, exclusive of costs for debt service, which is equal to or greater than that of comparable publicly-traded companies in its industry is an example of a company with a favorable operating margin. Since such margins vary by industry, the analysis of companies with favorable operating companies is performed based on an industry basis as viewed by the financial markets.

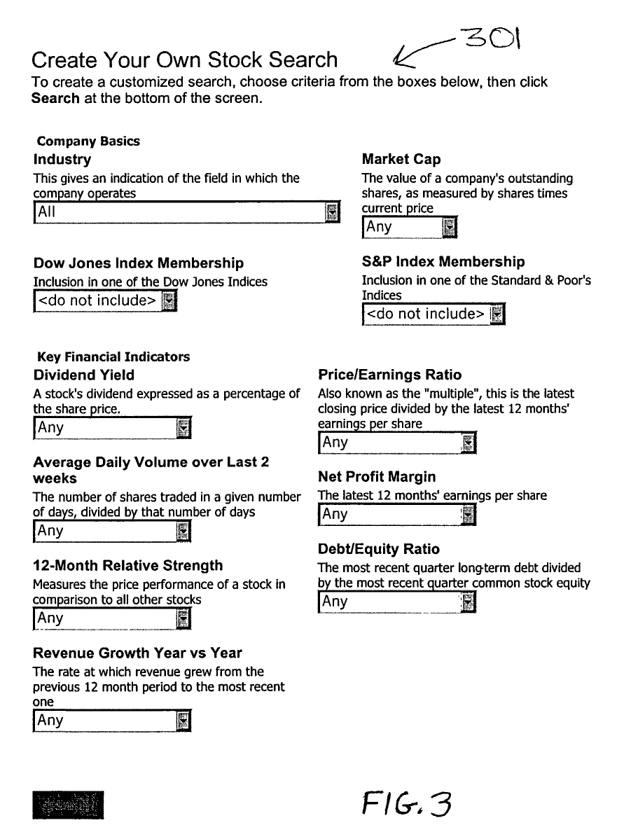

As one example of calculating favorable operating margins, metrics such as “Industry Average Return on Equity” or Industry Average Net Profit Margin are available in stock screening programs such as the publicly available stock screener provided by Microsoft at http://moneycentral.msn.com/investor/finder/customstocksdl.asp. FIG. 3 shows a web page interface 301 to the Microsoft stock screener. It should be noted that the while the web page interface shown in FIG. 3 lists just a few of the stock screening criteria, the commercially available Microsoft Stock Screener permits screening of stocks using one or more of over five hundred criteria. FIG. 3 is merely an illustration and should not limit the invention disclosed herein. One of ordinary skill in the art would recognize other variations, modifications, and alternatives all of which are within the scope of the present invention.

Candidate companies may be selected based on having operating margin metrics that compare favorably with their industry averages. In addition, the candidate companies may be selected based on two or more operational metrics. These two or more operational metrics can be used to calculate a composite or weighted average of the operational metrics to determine suitability as a candidate company. Developing such composite (or weighted) average derived from more than one operational metric is within the abilities of one skilled in the art. Furthermore, development of such composite metric calculations is particularly suited for being implemented using automated procedures for calculating the composite metric value from financial and operational data of the various companies that have been identified based on a stock screen.

It in this context, it is to be understood that the present invention contemplates that automated techniques for one or more of the following activities: receiving financial data of a target company, calculating and analyzing financial and operating data of the target company, determining industry classification of the target company (based on commonly available industry classifications used in the financial industry), calculating and comparing operating characteristics of the target company with average (including mean or mode) operating characteristics for similar companies in comparable industries; and providing an indication of the suitability of the target company based on the comparison of the operating characteristics of the target company to similar companies in its industry (using either a single operating characteristic or a composite value derived from several operating characteristics, as discussed above).

One such indication of the suitability of the target company may be determined by comparing the operating characteristics of target company to preset criteria. In one example of suitability based on a preset criteria, target companies whose operating characteristics are better than that of the average operating characteristics of similar companies in its industry, are selected as candidates for the next step. One skilled in the art would recognize that many other preset criteria may be used based on the comparison of either individual operating characteristic or composite operating characteristic of the candidate company to average (or other similar aggregate based) value of the individual or composite operating characteristics of comparable companies.

Such target companies that are selected are called “Identified Foreign Companies” (“IFC”)and can proceed to the next step 220 in accordance with the present invention. It should be understood that while IFC's may be foreign companies incorporated outside the U.S. in one embodiment, one skilled in the art would recognize that the method of the present invention may work equally well with U.S. companies with good operating margins that have a negative or low net worth caused by a rapid decline in asset value such as that caused, for example, by a stock market, real estate, or economic downturn that are often cyclical in nature. Such a rapid decline in asset value may be caused, for example, by a decline in value of real estate assets or financial assets. If such real estate assets or financial assets were provided as a collateral to a loan, these companies would also possibly possess negative or very low net worth while having good operating margins that would enable such a company to qualify as an IFC for the purposes of the present invention.

Agreement with IFC (Step 220)

The Sponsor enters into an agreement with the IFC. The agreement provides details of the services to be performed by the Sponsor on behalf of the IFC, and the Sponsor's compensation for such services. Examples of services provided by the Sponsor include without limitation: (a) writing a detailed business plan, (b) finding potential merger partners, and negotiating the terms for such merger(s), (c) introducing IFC to firms providing investor relations services, (d) introducing IFC to firms that make markets in publicly-traded securities on different exchanges, or (e) introducing IFC to potential institutional investors.

Details of such an agreement is preferably recorded on a computer database such that checks related to the existence and sufficiency of the agreement can be automatically searched and verified.

Finding Comparable US-Listed Companies (Step 230)

Next, a stock screening program, such as the MSN Money Deluxe stock screener available on the Internet at http://moneycentral.msn.com/investor/finder/customstocksdl.asp (see exemplary web page interface shown in FIG. 3) is used to find comparable companies listed on major U.S or other international exchanges, in the same or similar industry and with comparable margins (“comparables”) and to find the comparable multiple of sales and earnings that are accorded to comparable companies in the U.S. market. Alternatively, as would be recognized by those skilled in the art, a customized software application can be used to access a database containing financial data of companies listed in one or more of the U.S. or other international exchanges of interest to identify comparable companies.

The exemplary screening program, MSN Money Deluxe, is a computer application that accesses an extensive and constantly updated database. The data base contains a wealth of data on publicly traded companies, including without limitation, details on sales, operating margins, shares outstanding and return on investment, as well as many measures of typical financial or operating performance by industry as would be recognized by those skilled in the art. Criteria are selected based on company related data, such as, industry, company size, company sales, price/earnings, and/or price/sales ratios to find comparable companies. Other criteria that may be used include, without limitation, type of product, type of service, amount and type of debt, geographical location, and/or authorized versus issued stock.

One skilled in the art would recognize how to use one or more company related data to identify comparables to the target company based on comparison of the financial data and the industry between the IFC and the companies on the U.S. or other exchanges of interest. Furthermore, in one embodiment, this comparison is performed using software that inputs the IFC's financial data and industry data and compares those to other companies' financial and industry data to identify companies that match one or more predefined criteria. One skilled in the art would recognize that criteria for identifying comparable companies may be multi-factored so that a composite value based on multiple factors may be used to performing an automated comparison. Furthermore, in one aspect of the invention, the comparable companies may be ranked based on the several factors and a ranking based composite value may be used to identify comparable companies as would be within the abilities of one of ordinary skill in the art.

Next, a target market capitalization is determined for the Identified Foreign Company, preferably by using a computer to apply the multiples corresponding to the comparable companies determined in the preceding step to the financial data of the target company. This target market capitalization is defined as the “inherent value” of the target company.

For example, companies in a particular industry, for example the gaming industry, and with a size of over $100 million in sales per year have an average price/earnings multiple of 20. A computer application can determine that if such a company has a 10% margin (again based on industry averages of companies of comparable size) it would have earnings of $10 million. Based on the above earnings calculation, the computer application would determine that such a company would have a market capitalization of $200 million using the price/earnings multiple of 20. One skilled in the art would recognize that this is just one example of calculating a target market capitalization of the IFC based on industry average margin and price/earnings ratios. One skilled in the art would recognize that several other methods of calculating target market capitalization using financial data of comparable companies may also be used instead. Furthermore, as would be recognized by those skilled in the art, the target market capitalization of the IFC may have a premium or discount—to the industry data based calculation of the market capitalization—associated with specifics related to the business or circumstances of the IFC.

Identifying and Valuing a Partner for a Reverse Merger (Step 240)

Once an IFC has been identified with suitable inherent value as defined in the preceding paragraph, a computer and/or internet based analysis is preferably used to optionally identify a suitable merger partner.

A suitable merger partner is a publicly-traded company, preferably on a U.S. exchange or marketplace (or a desired international exchange or market place) with much smaller sales and earnings than the IFC, whose shareholders can benefit from merging with the larger IFC. The public company may be fully-reporting or may be behind in its reporting, in which case it needs to be brought into full compliance with the reporting requirements. It may be listed on the “Over the Counter” market known as the Bulletin Board System (BBS), that are quoted at http://www.nasdaq.com or they may be listed on, for example and without limitation, the NASDAQ SmallCap, The NASDAQ National Market System, the American Stock Exchange or the New York Stock Exchange. It may also be quoted on “The Pink Sheets” at http://www.pinksheets.com. Such merger partners may have been created especially for the purpose, or they may existing companies that have not fulfilled the hopes of their investors for various reasons.

Such companies, known as Target Merger Partners (“TMP”) may be identified by contacting brokers, or may be found using screening software such as is used for identifying comparables based on financial data and/or industry average or related data. Whether screening software or broker proposals are used to identify companies, in one embodiment the criteria to be used include, without limitation, (a) market capitalization (lower the better), (b) a large base of shareholders (preferably from 300 to several thousand, with a small number of shareholders (preferably under 10) controlling more than 51% of the company, (c) absence of litigation or regulatory complaints, (d) preferably a similar line of business (not mandatory), and/or (e) a moderate cost of acquisition.

A computer application is preferably used to analyze and value TMPs on the basis of various criteria, such as (a) degree of compliance with reporting and other requirements, (b) number of shareholders, (c) number of shares authorized, issued and outstanding, (d) public float and number of unique shareholders, (e) potential and actual litigation, and other factors affecting valuation. A TMP that is not fully reporting, or not in full compliance with be accorded a lower value than one which is fully reporting and in full compliance because more time and expense is required to bring the TMP into full compliance. A TMP with numerous shareholders is more desirable than a TMP with only a few shareholders, since each existing shareholder is a prospect for purchasing additional shares once the TMP merges with the IFC. Any cash or other valuable and liquid assets in the TMP will be accorded the value of such assets. A TMP with many authorized but unissued shares is more desirable than one with few authorized but unissued shares, as time-consuming and expensive approvals of shareholders may need to be sought to authorize issue of additional shares. Litigation or the threat of litigation adversely affects the valuation of a TMP because of the potential for distraction of management post-merger with the IFC, and the need to procure insurance against such potential exposure. A company that is listed on the Amex, The NASDAQ NMS or the NYSE is most desirable. A NASDAQ SmallCap TMP will generally be worth more than one listed on the NASDAQ OTC, which in turn will generally be worth more than one trading on the pink sheets. The speed at which a transaction can be completed also may have a bearing on valuation.

One or more of these criteria may be entered into a computer application to identify TMPs based on financial data accessed from commercially available sources. Furthermore, additional qualitative data (or a weighted score based thereon) may be entered to account for the some or all of the other factors described above that influence the desirability of a company as a TMP. Furthermore, the computer application may also be programmed to provide a multi-dimensional ranking of potential TMPs identified by the computer application. In the multi-dimensional ranking of potential TMPs, the TMPs may be ranked along several of the criteria discussed earlier herein so that a composite measure based on the several rankings may be used to screen or select the TMPs.

Based on the valuation and desirability, negotiation is entered into with a TMP to determine the relative equity share to be retained by the TMP's existing shareholders with respect to the equity to be provided to the shareholders of the IFC.

A binding Memorandum of Understanding (“MOU”) or other similar agreement is preferably entered into between the Sponsor, on behalf of the IFC, and the TMP. Upon execution of the MOU the TMP is now known as the Merger Partner (“MP”).

In an alternative embodiment, an alternative to a merger with a TMP is an initial public offering of a newly formed U.S. entity. The IFC can merge directly with the newly formed US entity or become a subsidiary of the newly-formed entity, which would then be a holding company controlling the IFC. The U.S. entity can then go through the full registration of its securities. Although this process is typically more time-consuming, it may be most appropriate in certain situations, particularly in situations where the IFC has unique and proprietary technology. The merger with a newly-formed US entity is necessary to make the resulting company a U.S. company and fully subject to U.S. securities regulations.

Negotiation with Lenders (Step 250)

As soon as an MOU is signed, the Sponsor and the IFC negotiate with the IFC's lenders to agree to exchange a major portion of the IFC's debt for equity in the US public entity once the IFC completes its merger into a public entity whose shares are listed on a major U.S. exchange (as discussed above in step 240). The debtholder (or lender), who generally is holding a non-performing loan, is usually willing to exchange a major portion of such loan for equity in a publicly-traded entity quoted on a major U.S. exchange, as accounting rules permit the debtholder to “mark to the market” the value of such shares, thereby giving the debtholder a larger reportable profit on a debt that has most-likely been substantially written down. Computerized analysis may also be used to determine the appropriate number of shares to be exchanged for the loan based on the expected value of the shares. In one example, the expected value of the shares may be determined based on the target market capitalization, as discussed earlier, and the total number of authorized or issued shares.

The debtholder may need to agree to various restrictions on their use of the received shares, such as, lockup, non-shorting, and “dribble-out” rules so that the shares received will not flood the market and adversely affect stock price in, for example, a short or medium term. A computer application is preferably used to determine appropriate levels of permitted monthly trading based on the merged public company's trading history once its shares begin to trade.

Formation of New Public Entity and Compliance with Applicable Law (Step 260)

A merger of the IFC and the MP requires, for example, a filing of a Form S-8 with the U.S. Securities and Exchange Commission, which discloses, among other requirements, a detailed business plan for the merged companies, and audited financial statements, according the U.S. Generally Accepted Accounting Principles (“US GAAP”) for both the MP and the IFC. Shareholder approval may be needed to authorize additional shares, and to approve a name change, if desired. Exchange approval may be needed for a change in trading symbol and for listing of the merged company on a more liquid exchange, such as the NASDAQ National Market System. Other formalities for completing the merger are also completed at this time as would be recognized by those skilled in the art.

Once applicable laws have been complied with, and any needed approvals obtained, the merger is closed, and the merged company trades with its new trading symbol or the selected exchange. The merged company is referred to herein as the New Public Entity (“NPE”).

Using the Equity in the New Public Entity (Step 270)

The present invention provides for the appropriate use of the equity in the NPE to enhance the value of the transaction in accordance with the present invention as discussed in the following three subsections.

Obtaining Market Makers and Increasing Investor Interest

The Sponsor arranges for suitable competitive market makers to make a market in the NPE's stock and to increase investor awareness through a suitable investor relations program targeted to individual and/or institutional investors, as appropriate. For example, investor relations may include a process of increasing the awareness of the NPE to targeted investors, who may be certain institutional investors or certain groups of individual investors. Developing and executing such investor relations programs are within the abilities of those skilled in the art. In one example, the steps to be taken include one or more of the following.

(a) Identification of the target investor groups, targeted brokers, and targeted analysts based on the NPE's fundamentals. For example, certain institutional funds target companies with a share price of over $7.50 and a market capitalization of over $500 million; others may target based on different criteria for (i) size, (ii) profitability, (iii) share price, and/or (iv) market capitalization. Certain investors, brokers, and analysts specialize in certain industries.

(b) Preparation of written materials targeting the potential investors.

(c) Contacting the potential investors in an appropriate and cost-effective manner, based on the anticipated potential investment. For example, smaller investors may be contacted via email or facsimile, medium-sized investors may be invited to “road shows”, and larger investors may be visited in person. Groups indirectly investing or influencing investors, e.g., analysts and brokers are also appropriately contacted using, among others, e-mail or other electronic communication means.

Exchange of Debt for Equity

A feature of present invention is that once the NPE begins trading and its value becomes recognized, the previously-negotiated agreement between the debtholder and the NPE takes effect, giving the NPE a large increase in tangible net worth, since its debt is replaced by equity issued to the debtholder in exchange for cancellation of the debt, further increasing the attractiveness of the NPE to investors.

Access to Capital Markets

Once the NPE begins trading and converts its debt to equity, as described above, it is then in a position to further access U.S. capital markets in various ways, including: (a) sales of equity through, for example, a private investment in a public entity (“PIPE”), (b) an underwritten secondary offering, (c) sale of debt instruments, or (d) a combination of two or more of the above. The Sponsor may continue to advise the NPE on the best ways to achieve its goals, given prevailing current market conditions.

In summary, in one aspect, the present invention provides a unique set of steps that provides foreign or other entities with access the U.S. or other targeted capital markets. In particular, the combination of a reverse merger and the conversion of debt into equity between the parties as outlined in the method of the present invention represents a unique method that provides improved access to public financing markets to companies with limited or negative net worth even through the companies have adequate operating margins. Computer applications automate several of the unique steps and provide screening, analysis, and calculations involving data from a large number of potential companies as well as other calculations and verifications related to the progress of the steps of the present invention.

Example of Transaction

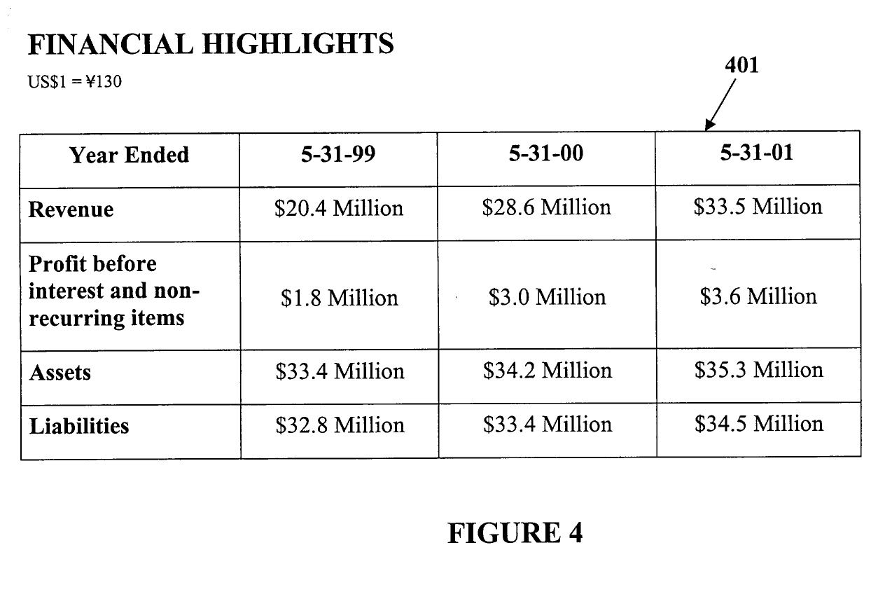

Company A is a pachinko (or game parlor) company in Japan that has a good earnings stream from its popular game parlors. However, Company A has invested heavily in real estate to locate the game parlors in desirable locations and, therefore, has a low or negative net worth since the real estate values have declined sharply since the time the real estate was purchased or leased. Accordingly, the real estate loans on the books of Company A may exceed the value of the real estate owned or leased and contributes to its low or negative net worth even though the game parlors are very successful and the Company A has a good operating income. Therefore, Company A is a suitable company for the transaction in accordance with the present invention. FIG. 4 is table 401 listing some of the relevant financial data for Company A.

To facilitate the transaction, Company A takes the following steps: (a) secures $6 million dollar equity financing; and (b) negotiates with the creditors to buyout non performing loans of $30 million for $5 million dollars (and optionally an agreement to get stock in the new public entity to be formed in accordance with the transaction according to the present invention). These steps make Company A debt free and strengthens its balance sheet.

Next, a target merger Company B is identified in accordance with the disclosure of the present invention earlier herein. The target merger company B spins of a subsidiary company (Company C) that is to be listed in a target market of interest (for example, in the NASDAQ). Before, the financing step, Company C will have 10 million shares outstanding with 7 million shares to the existing shareholders of Company A and 3 million to the existing shareholders of Company B.

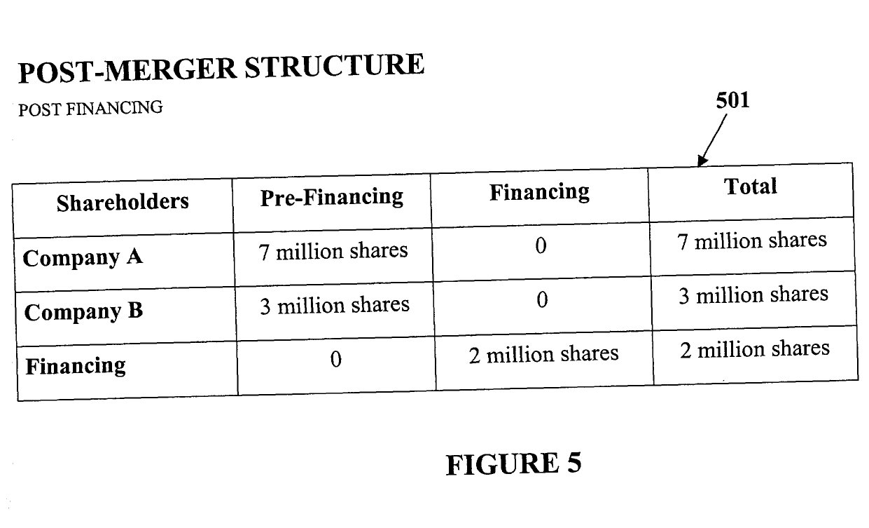

After financing is arranged (and/or in exchange for the buyout of the loans), a financing company (and/or the creditors of Company A) are given 2 million shares so that the post merger share ownership is as shown in table 501 in FIG. 5.

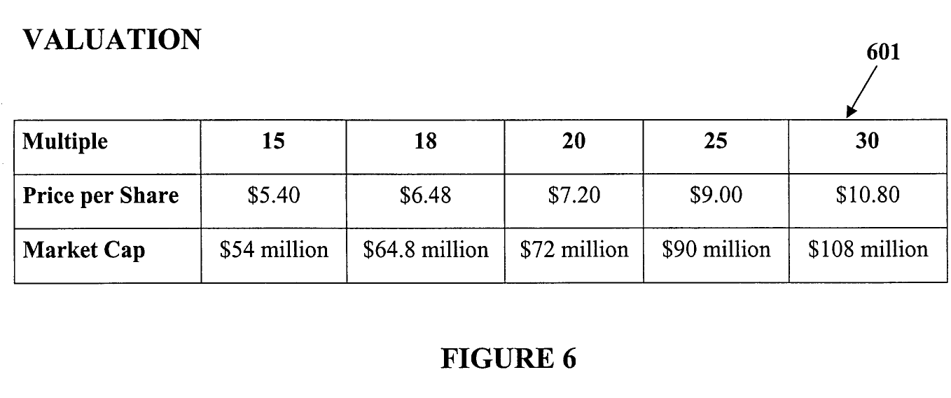

As shown in Table 601 in FIG. 6, the market capitalization for the original shareholders of Companies A and B are shown with typical financial ratios that may be associated for similar companies (or companies in a similar industry) for the target market. Based on Company A's operating earnings of $3.6 millions (as shown In FIG. 4) and additional earnings generated by the original Company B assets contributed to merged Company C (i.e., the new public entity), the earnings per share (EPS) of Company C is 0.36 $/share. On a typical price/earnings (P/E) ratio of 15, the price of each share of company C is worth $5.40 and the 10 million shares owned by the original shareholders of the companies A and B is worth $54 million (in terms of market capitalization). Likewise, Table 601 displays other valuations for the original shareholders of companies A and B based on other typical P/E ratios. For example, a P/E ratio of 20 yields a market valuation of $72 million owned by the original shareholders of companies A and B, while a P/E ration of 30 yields a market capitalization of $108 million. Accordingly, the shareholders of companies, such as Company A, that has good operating earnings but a poor balance sheet because of decline in the value of their assets, are able to leverage the good operating earnings to create market capitalization that can be used to further expand their business or for other productive purposes.

It will also be recognized that the original creditors also gain in this scenario since they are also able to add the value of their 2 million shares (or part thereof) to any amount that they received when buying out the non performing or under collateralized loans to company A, while removing the under performing or under collateralized loans from their books.

Other embodiments of the invention will be apparent to those skilled in the art from a consideration of the specification and the practice of the invention disclosed herein. It is intended that the specification be considered as exemplary only, with such other embodiments also being considered as a part of the invention in light of the specification and the claims of the invention disclosed herein.

What is claimed is:

1. A computer implemented method of enhancing valuations of companies having limited or negative worth using a reverse merger, comprising the steps of:
identifying a suitable company based on financial and operational data of companies;
finding comparable listed companies on a target market or exchange;
identifying a target merger partner from the comparable listed companies based on a selection criteria;
merging the suitable company and the target merger company to form a new public entity that is listed in the target market or exchange; and
exchanging at least some of the debt or liabilities in the suitable company with equity in the new public entity.

2. The computer implemented method according to claim 1, wherein the step of identifying a suitable company comprises evaluating financial data of the companies.

3. The computer implemented method according to claim 2, wherein the financial data includes one or more of sales history, cost of goods sold, assets, liabilities, or financial ratios.

4. The computer implemented method according to claim 1, wherein the step of identifying a suitable company comprises evaluating the financial data of a company against average or other aggregate values of other companies in a similar industry.

5. The computer implemented method according to claim 1, wherein the step of evaluating a suitable company comprises evaluating operational data of companies including one or more of access or contracts to valuable resources, government contracts, geographical location, or intellectual property.

6. The computer implemented method according to claim 5, wherein the step of evaluating a suitable company comprises evaluating both financial and operational data and deriving a ranking based on a composite value derived from both financial and operational data.

7. The computer implemented method according to claim 1, wherein the step of identifying suitable companies comprises identifying companies with higher operating margins relative to their net worth.

8. The computer implemented method according to claim 1, wherein the step of identifying suitable companies comprises using a commercial or customized stock screener program that screens stocks of publicly traded companies based on one or more financial or operational criteria.

9. The computer implemented method according to claim 1, wherein the step of finding comparable listed companies comprises using a commercial or customized stock screener program that screens stocks of publicly traded companies based on one or more financial or operational criteria.

10. The computer implemented method according to claim 1, wherein the step of finding a target merger partner comprises selecting a company from the comparable listed companies using a selection criteria.

11. The computer implemented method according to claim 10, wherein the selection criteria comprises evaluating one or more of factors related to the companies including industry, company size, company sales, price/earnings ratio, price/sales ratio, type of product or service offered, amount and type of debt, geographical location, types and number of shareholders, and authorized versus issued shares.

12. The computer implemented method according to claim 11, wherein the selection criteria comprises using a composite value developed from one or more of the factors.

13. The computer implemented method according to claim 1, wherein the step of exchanging at least some of the debt or liabilities comprises determining a target market capitalization.

14. The computer implemented method according to claim 13, wherein the target market capitalization is determined based on the operational earnings of the suitable company or the new public entity, and financial ratios of comparable companies in the target market or exchange.

15. The computer implemented method according to claim 14, wherein the financial ratios of comparable companies comprises a price/earnings ratio of comparable companies on the target market or exchange.

16. The computer implemented method according to claim 13, wherein a discount factor is applied in calculating a target market capitalization based on the comparable companies in the target market or exchange.

17. The computer implemented method according to claim 13, wherein the step of exchanging at least some of the debt or liabilities comprises determining an amount of the debt or liabilities to be exchanged based on the determination of the target market capitalization value.

18. The computer implemented method according to claim 13, wherein the suitable company comprises a game parlor or pachinko company.

19. A computer readable data medium having program code stored thereon for enhancing valuations of companies having a limited or negative net worth by causing a computing system to perform the steps comprising:
identifying a suitable company based on financial and operational data of companies;
finding comparable listed companies on a target market or exchange;
identifying a target merger partner from the comparable listed companies based on a selection criteria;
merging the suitable company and the target merger company to form a new public entity that is listed in the target market or exchange; and
exchanging at least some of the debt or liabilities in the suitable company with equity in the new public entity.

20. The computer readable data storage medium according to claim 19, wherein the step of identifying a suitable company comprises evaluating financial data of a company against average or other aggregate values of other companies in a similar industry.

21. The computer readable medium according to claim 19, wherein the step of evaluating a suitable company comprises evaluating operational data of companies including one or more of access or contract to valuable resources, government contracts, geographical location, or intellectual property.

22. The computer readable medium according to claim 19, wherein the step of evaluating a suitable company comprises evaluating both financial and operational data and deriving a ranking based on a composite value derived from both financial and operational data.

23. The computer readable medium according to claim 19, wherein the step of identifying suitable companies comprises identifying companies with higher operating margins relative to their net worth.

24. The computer readable medium according to claim 19, wherein the step of exchanging at least some of the debt or liabilities comprises determining a target market capitalization.

25. The computer readable medium according to claim 23, wherein the step of exchanging at least some of the debt or liabilities further comprises determining an amount of the debt or liabilities to be exchanged based on the determination of the target market capitalization value.

26. A computing system for enhancing valuations of companies having limited or negative net worth using a reverse merger, comprising:
means for finding comparable listed companies on a target market or exchange;
means for identifying a target merger partner from the comparable listed companies based on a selection criteria;
means for merging the suitable company and the target merger company to form a new public entity that is listed in the target market or exchange; and
means for exchanging at least some of the debt or liabilities in the suitable company with equity in the new public entity.

27. A computing system for enhancing valuations of companies having a limited or negative net worth using a reverse merger, comprising:
an identification unit that identifies a suitable company based on financial and operational data of companies;
a screening unit that screens comparable listed companies in a target market or exchange;
a identification unit that identifies a target merger partner from the comparable listed companies based on a selection criteria
merging unit that records and calculates information regarding the merger of the suitable company and the target merger company to form a new public entity that is listed in the target market; and
an exchange unit that calculates and determines the exchanging of at least some of the debt or liabilities in the suitable company for equity in the new public entity.
